(19) United States
(12) Patent Application Publication
(10) Pub. No.: US 2024/0141171 A1
(43) Pub. Date: May 2, 2024

(54) USE OF FERMENTED MOLASSES AS AN EMULSIFIER

(71) Applicant: LESAFFRE ET COMPAGNIE, Paris (FR)

(72) Inventor: Xavier LEBRUN, Marquette-Lez-Lille (FR)

(21) Appl. No.: 18/563,806

(22) PCT Filed: Jun. 2, 2022
(86) PCT No.: PCT/FR2022/051047

§ 371 Date: Nov. 22, 2023

(30) Foreign Application Priority Data
Jun. 3, 2021 (FR) 2105874

(51) Int. Cl. C08L 95/00; C08K 11/00

(52) U.S. Cl. CPC C08L 95/005; C08K 11/00; C08L 2555/40

(57) ABSTRACT

The invention relates to the use of fermented molasses as an emulsifier in an emulsion. The invention also relates to an emulsion comprising a bitumen and fermented molasses.

### FIELD OF THE INVENTION

The present invention relates to a novel use of fermented molasses as an emulsifier.

### TECHNICAL BACKGROUND

Bitumen emulsions allow the fluidization of a bitumen that is too thick to permit pouring. Typically, these emulsions are composed of bitumen, water at acid pH, and amine derivatives as emulsifier. However, these amine derivatives are highly toxic for the environment.

Molasses is a co-product derived from the production of sugar, conventionally from sugar beet and sugar cane in sugar plant, or from brown sugars in refinery. The sugar production process, whether from cane or beet, leads to the obtaining of sugar and of molasses after the crystallization step.

Although used for extraction of glycine betaine therefrom which, after esterification, is used as surfactant, beet molasses just like cane molasses is more generally used as animal feed in a mixture with straw or other cellulosic foodstuff, but also as binder in full animal rations, or to promote the ingestion by animals of scarcely appetizing feed.

As an alternative to animal feed, molasses is also used by industrialists for the production of so-called “noble” products through fermentation processes. Via fermentation mechanisms possessed by some microorganisms, molasses can be used as substrate and in particular allows the obtaining of baker's yeast, ethyl alcohol, citric and glutamic acids, lysine or of antibiotics.

On the other hand, the use of molasses via fermentation processes generates large quantities of liquid fermentation residues. These liquid fermentation residues correspond to the fermented molasses.

Having been depleted of constituents by microorganisms, fermented molasses is globally considered to be fermentation residue of little interest, and it is chiefly recovered in the agricultural sector to be spread as fertilizer.

Other uses have been described.

Document WO 2019/106190 concerns the use of fermented molasses as binding and/or disintegrating agent, in a compressed solid composition.

Document WO 02/063941 describes an oil/water emulsion in which the aqueous phase comprises water and a by-product of agriculture or fermentation such as molasses, vinasse and/or syrup, and the oil phase contains oil and emulsifiers.

There is a true need for providing economical emulsifiers that are more environmentally friendly.

### SUMMARY OF THE INVENTION

The invention first concerns the use of a fermented molasses as emulsifier in an emulsion.

In some embodiments, the emulsion is an oil-in-water emulsion.

In some embodiments, the fermented molasses is fermented beet molasses and/or fermented cane molasses.

In some embodiments, the fermented molasses is fermented beet molasses.

In some embodiments, the fermented molasses is demineralized fermented molasses.

In some embodiments, the fermented molasses is depotassified fermented molasses.

In some embodiments, the fermented molasses is contained in the emulsion in an amount of from 25 to 85% by weight, preferably from 25 to 60% by weight, more preferably from 25 to 50% by weight, further preferably from 30 to 40% by weight, relative to the total weight of the emulsion.

In some embodiments, the emulsion comprises an amount of oil phase of 15 to 75% by weight, preferably from 40 to 75% by weight, more preferably from 50 to 75% by weight, further preferably from 60 to 70% by weight, relative to the total weight of the emulsion.

In some embodiments, the fermented molasses has a dry matter content of from 50 to 90% by weight, preferably of from 55 to 65% by weight.

In some embodiments, the pH of the emulsion is from 2 to 11.

In some embodiments, the emulsion is a bitumen or petroleum emulsion, preferably the emulsion is a bitumen emulsion.

In some embodiments, the emulsion is at a temperature higher than 40° C.

In some embodiments, the emulsion is or is included in a food product, a cosmetic product, a plant protection product, a medicinal product, a paint, a flotation medium, a detergent or cleaning product, a reaction medium such as a polymerization medium, an enhanced oil recovery fluid, or an adhesive.

The invention also concerns an emulsion preferably an oil-in-water emulsion, comprising a bitumen and a fermented molasses.

The present invention enables to meet the above-expressed need. It more particularly provides a system having good emulsifying properties and allowing the obtaining of stable emulsions that are non-toxic and environmentally friendly, whilst remaining economical. In addition, the invention allows the recovery of a by-product from the fermentation of molasses.

This is achieved through the use of fermented molasses as emulsifier, to prepare an emulsion. It has surprisingly been discovered that, intrinsically, fermented molasses has low interfacial tension compared with water and that, when it is mixed with an oil phase, it is capable of forming an emulsion, the fermented molasses acting both as aqueous phase and as surfactant.

### BRIEF DESCRIPTION OF THE FIGURES

FIG. 1 shows an optical microscopy image of Emulsion No 1 such as described in Example 3.

FIG. 2 shows an optical microscopy image of Emulsion No 2 such as described in Example 3.

FIG. 3 shows the rheological curves obtained for Emulsion No 1 (curve C), for Emulsion No 2 (curve D) and for pure heavy crude oil (light grey curve A) with a rheometer in plane-plane configuration, and the rheological curve obtained for pure heavy crude oil by a rheometer in cone-plane configuration (dark grey curve B), such as described in Example 3. The X-axis represents the applied shear rate (in s⁻¹) on a logarithmic scale, and the Y-axis represents the dynamic viscosity of the tested composition (in Pa·s) on a logarithmic scale.

FIG. 4 shows an optical microscopy image of Emulsion No 3 such as described in Example 4.

FIG. 5 shows an optical microscopy image of Emulsion No 4 such as described in Example 4.

FIG. 6 shows an optical microscopy image of Emulsion No 5 such as described in Example 4.

FIG. 7 shows the rheological curves obtained for Emulsion No 3 (curve G), for Emulsion No 4 (curve H), for Emulsion No 5 (curve F) and for pure bitumen (curve E), such as described in Example 4. The x-axis represents the applied shear rate (in s⁻¹) on a logarithmic scale, and the Y-axis represents the dynamic viscosity of the tested composition (in Pa·s) on a logarithmic scale.

FIG. 8 shows the rheological curves obtained for Emulsion No 6 (curve J), and for pure bitumen (curve I), such as described in Example 5. The X-axis represents the applied shear rate (in s⁻¹) on a logarithmic scale, and the Y-axis represents the dynamic viscosity of the tested composition (in Pa·s) on a logarithmic scale.

FIG. 9 shows an optical microscopy image of Emulsion No 7, after preparation thereof, such as described in Example 6.

FIG. 10 shows an optical microscopy image of Emulsion No 8, after preparation thereof, such as described in Example 6.

FIG. 11 shows an optical microscopy image of Emulsion No 7, 20 days after preparation thereof, such as described in Example 6.

FIG. 12 shows an optical microscopy image of Emulsion No 8, 20 days after preparation thereof, such as described in Example 6.

FIG. 13 shows an optical microscopy image of Emulsion No 9, of pH 10, such as described in Example 7.

FIG. 14 shows an optical microscopy image of Emulsion No 10, of pH 3, such as described in Example 7.

FIG. 15 shows an optical microscopy image of Emulsion No 11, of pH 6, such as described in Example 8.

FIG. 16 shows an optical microscopy image of Emulsion No 12, of pH 10, such as described in Example 8.

### DETAILED DESCRIPTION

The invention will now be described in more nonlimiting detail in the following description.

Herein, and unless expressly stated otherwise, all indicated percentages (%) are weight percentages.

The invention relates to the use of fermented molasses as emulsifier in an emulsion.

In the meaning of the present invention, by “fermented molasses” it is meant a fermented molasses that has not been subjected to an esterification process (for example, for the purpose of esterifying the glycine betaine contained in fermented beet molasses).

As previously mentioned, the fermented molasses is a co-product of the molasses obtained after fermentation thereof by bacteria, yeasts or fungi, said fermentation for example allowing so-called “noble” products to be obtained such as baker's yeast, ethyl alcohol, citric acid or glutamic acid.

The fermented molasses used in the invention can be fermented beet molasses or fermented cane molasses. Alternatively, the fermented molasses used in the invention can be a mixture of fermented beet molasses and fermented cane molasses. For example, the mixture may comprise from 1 to 25% by weight of fermented beet molasses and from 75 to 99% by weight of fermented cane molasses, or from 25 to 50% by weight of fermented beet molasses and from 50 to 75% by weight of fermented cane molasses, or from 50 to 75% by weight of fermented beet molasses and from 25 to 50% by weight of fermented cane molasses, or from 75 to 99% by weight of fermented beet molasses and from 1 to 25% by weight of fermented cane molasses. In particularly preferred manner, the fermented molasses of the invention comprises from 75 to 100% by weight of fermented beet molasses and from 0 to 25% by weight of fermented cane molasses.

More preferably, the fermented molasses used is a fermented beet molasses. Fermented beet molasses allows the obtaining of a lower interfacial tension with an oil phase than fermented cane molasses, and has therefore better emulsifying properties than fermented cane molasses.

Fermented cane molasses has slight shear thinning rheological behaviour (the viscosity thereof is dependent on shear rate), whilst fermented beet molasses has almost Newtonian rheological behaviour. The more the fermented molasses has shear thinning rheological behaviour, the more the stability of the emulsion is increased.

Advantageously, the fermented molasses is obtained by fermentation of the molasses by yeasts.

Preferably, the fermented molasses incorporated in the emulsion has a dry matter content of 50 to 90% by weight, preferably of 55 to 65% by weight, more preferably 58 to 62% by weight. In particular, the fermented molasses may comprise from 50 to 55% by weight, or 55 to 58% by weight, or 58 to 60% by weight, or 60 to 62% by weight, or 62 to 65% by weight, or 65 to 70% by weight, or 70 to 75% by weight, or 75 to 80% by weight, or 80 to 85% by weight, or 85 to 90% by weight of dry matter. Preferably, the remainder of the fermented molasses is water (the fermented molasses incorporated in the emulsion may therefore comprise from 10 to 50% by weight of water, preferably 35 to 45% by weight of water, more preferably 38 to 42% by weight of water).

The fermented molasses recovered after the fermentation bath generally contains from 5 to 10% by weight of dry matter (and therefore 90 to 95% by weight of water). The fermented molasses such as recovered after the fermentation process may undergo concentration to reduce the amount of water, or dilution preferably with water, for example to reach a dry matter content in one of the above-mentioned ranges.

The fermented molasses incorporated in the emulsion can be a demineralized fermented molasses. Demineralization for example may entail precipitation of the salts of potassium sulfate (K₂SO₄), sodium sulfate (Na₂SO₄), magnesium sulfate (MgSO₄), and calcium sulfate (CaSO₄) through the addition of sulfuric acid. Advantageously, demineralization allows an increase in the proportion of organic matter within the fermented molasses and an increase in the proportion of surfactant molecules of the molasses relative to the total dry matter in the fermented molasses.

The fermented molasses incorporated in the emulsion can be fermented molasses that is depotassified, for example via acidification with a sulfuric acid solution followed by neutralization with ammonia.

Alternatively, the fermented molasses used to form the emulsion can be so-called “crude” fermented molasses i.e. it has not been subjected to any chemical or physicochemical treatment (crude fermented molasses may however have been concentrated or diluted).

a. The fermented molasses can be defined by the distribution of nitrogen-containing material and an aminogram. The fermented molasses of the invention can therefore have the following distribution of nitrogen-containing materials:
nitrogen from total amino acids determined by the Kjeldahl method: 25% to 100% by weight of total nitrogen,
betaine nitrogen: 0% to 50% by weight of total nitrogen,
ammoniacal nitrogen: 0% to 30% by weight of total nitrogen.

More particularly, the fermented molasses of the invention can have the following distribution of nitrogen-containing materials, in particular if it is fermented beet molasses:
nitrogen from total amino acids determined by the Kjeldahl method: 25% to 50% by weight of total nitrogen,
betaine nitrogen: 40% to 50% by weight of total nitrogen,
ammoniacal nitrogen: 2% to 3% by weight of total nitrogen.

Alternatively, the fermented molasses of the invention can have the following distribution of nitrogen-containing materials, in particular if it is fermented cane molasses:
nitrogen from total amino acids determined by the Kjeldahl method: 70% to 100% by weight of total nitrogen,
ammoniacal nitrogen: 0% to 30% by weight of total nitrogen.

With regard to the aminogram of the protides of the fermented molasses of the invention, the mean contents of amino acids can be the following (the ranges of contents are given in g/kg dry matter of the fermented molasses):
aspartic acid: 6-8;
threonine: 0.5-3;
serine glutamic acid: 115-130;
proline: 3-4;
glycine: 4-5;
alanine: 2.5-3.5;
valine: 2.5-3.5;
methionine and cysteine: 0.5-3;
isoleucine: 1.5-2.5;
tyrosine: 2-3.5;
leucine: 3-4.5;
phenylalanine: 1-2;
lysine: 0.5-2.5;
histidine: 0.5-2; and
arginine: 0.2-1.

The fermented molasses has a low sugar content, the sugar having been consumed by the microorganisms during the fermentation process. By “/ow sugar content” it is meant that the sugar content is lower than or equal to 5% by weight, or lower than or equal to 4% by weight, or lower than or equal to 3% by weight, or lower than or equal to 2% by weight, and preferably lower than or equal to 1% by weight relative to the total weight of the dry extract of fermented molasses. More preferably, the fermented molasses of the invention is free of sugars.

The fermented molasses used in the invention can have a density of 1.10 to 1.50, preferably from 1.20 to 1.40, and more particularly of 1.25 to 1.35. The density of the fermented molasses can be determined with a DMA®4500M density meter by Anton Paar at a temperature of 20° C., on a 2 mL sample.

The fermented molasses used in the invention can have viscosity at 20° C. of 50 to 6000 mPA·s, preferably of 500 to 5000 mPA·s, more preferably of 1000 to 4000 mPA·s. The viscosity can be measured with a Brookfield viscosimeter at a temperature of 20° C. and shear rate of 20 s⁻¹.

The fermented molasses used to form the emulsion can have a pH of 2 to 12.

In the invention the fermented molasses is used in an emulsion, as emulsifier. For this purpose, it is combined with an oil phase.

As an example, the oil phase may comprise or may be a vegetable oil, animal oil, mineral oil, petroleum, bitumen, a plant protection active ingredient, a therapeutic active ingredient, a pigment, resin or combinations thereof.

As vegetable oil, mention can be made for example of rapeseed oil, grapeseed oil, sweet almond oil, olive oil, jojoba oil and/or sunflower oil.

As animal oil, mention can be made of fish oils, cod liver oil, whale oil, sperm whale oil, and/or neatsfoot oil.

Advantageously, the amount of fermented molasses used in the emulsion is from 25 to 85% by weight, preferably from 25 to 60% by weight, more preferably from 25 to 50% by weight, further preferably from 30 to 40% by weight, relative to the total weight of the emulsion. In some embodiments, the amount of fermented molasses in the emulsion can be from 25 to 30% by weight, or from 30 to 35% by weight, or from 35 to 40% by weight, or from 40 to 45% by weight, or from 45 to 50% by weight, or from 50 to 55% by weight, or from 55 to 60% by weight, or from 60 to 65% by weight, or from 65 to 70% by weight, or from 70 to 75% by weight, or from 75 to 80% by weight, or from 80 to 85% by weight, relative to the total weight of the emulsion.

Preferably, the amount of oil phase in the emulsion is from 15 to 75% by weight, more preferably from 40 to 75% by weight, further preferably from 50 to 75% by weight, still further preferably from 60 to 70% by weight, relative to the total weight of the emulsion. In some embodiments, the amount of oil phase in the emulsion can be from 15 to 20% by weight, or from 20 to 25% by weight, or from 25 to 30% by weight, or from 30 to 35% by weight, or from 35 to 40% by weight, or from 40 to 45% by weight, or from 45 to 50% by weight, or from 50 to 55% by weight, or from 55 to 60% by weight, or from 60 to 65% by weight, or from 65 to 70% by weight, or from 70 to 75% by weight, relative to the total weight of the emulsion.

Preferably, the emulsion comprises at least 5% by weight, more preferably at least 10% by weight, further preferably at least 12% by weight, more particularly at least 15% by weight, of water relative to the total weight of the emulsion; for example from 10 to 40% by weight, or from 12 to 30% by weight of water. In some embodiments, the emulsion may comprise from 5 to 10% by weight, or from 10 to 12% by weight, or from 12 to 15% by weight or from 15 to 20% by weight, or from 20 to 25% by weight, or from 25 to 30% by weight, or from 30 to 35% by weight, or from 35 to 40% by weight of water, relative to the total weight of the emulsion.

The emulsion may have a dry matter content of 60 to 95%, preferably of 75 to 85% by weight. In particular, the emulsion can have a dry matter content of from 60 to 65%, or 65 to 70%, or 70 to 75% or 75 to 80%, or 80 to 85%, or 85 to 90%, or 90 to 95% by weight (relative to the total weight of the emulsion).

The emulsion may consist of the fermented molasses and the oil phase.

Alternatively, the fermented molasses and the oil phase can be combined with another aqueous solution to form the emulsion of the invention. As examples of aqueous solution, mention can be made of fruit juices, vinegars, floral waters and/or brine.

The aqueous phase of the emulsion advantageously has viscosity at 20° C. of 50 to 6000 mPA·s, preferably of 100 to 5000 mPA·s, more preferably of 150 to 4000 mPA·s. The viscosity can be measured as indicated above.

The emulsion may comprise one or more other surfactants, chosen for example from the group consisting of sorbitans and derivatives thereof, alkyl polyglucosides, sugar esters, esters of glycine betaine, rhamnolipids, surfactins, sophorolipids, glycolipids, beet pectins, phospholipids, lecithins, quaternary amines and derivatives thereof, fatty amines and amides, chitosan and derivatives thereof, and soaps and derivatives thereof. These surfactants can be contained in the emulsion in an amount of 0 to 10% by weight, preferably of 0 to 2% by weight, or 0.5 to 2% by weight (in particular when the emulsion is a bitumen emulsion).

Advantageously, the emulsion is free of surfactants other than the fermented molasses, in particular it is free of surfactants such as mentioned above.

The emulsion may contain one or more additives, in particular one or more hydrocolloids such as xanthan gums, celluloses, pectins, alginates and/or starches. These additives can be contained in the emulsion in an amount of 0 to 1% by weight, preferably from 0 to 0.5% by weight.

The emulsion advantageously has a pH ranging from 2 to 11, preferably from 5 to 11. The emulsion can have a pH of 2 to 3, or 3 to 4, or 4 to 5, or 5 to 6, or 6 to 7, or 7 to 8, or 8 to 9, or 9 to 10, or 10 to 11.

In particularly advantageous manner, the emulsion is an oil-in-water emulsion, i.e. the continuous phase is the aqueous phase and the dispersed phase is the oil phase.

The emulsion can be prepared by mixing the fermented molasses with at least one oil phase and optionally the other constituents of the emulsion (such as other surfactants, additives and/or one or more other aqueous solutions). Mixing can be carried out in a single step (the constituents are all added simultaneously to the mixture) or in several steps (pre-mixing of some constituents first being performed before adding the other constituents). Preferably, the oil phase is poured into the fermented molasses.

The mixing of the fermented molasses and oil phase (and optionally of the other constituents of the emulsion) can be performed using a homogenizer or disperser.

Mixing can be carried out for a time of 1 min to 1 h, preferably of 2 to 30 min, more preferably of 3 to 15 min, for example for a time of 5 min.

Advantageously, before being mixed with the fermented molasses, the oil phase is heated, preferably up to a temperature higher than or equal to 30° C., more preferably up to a temperature higher than or equal to 35° C., further preferably up to a temperature higher than or equal to 40° C. In some embodiments, the oil phase can be heated can be heated up to a temperature higher than or equal to 50° C., or higher than or equal to 60° C., or higher than or equal to 70° C., or higher than or equal to 80° C.

The temperature of the fermented molasses, at the time it is mixed with the oil phase, can be ambient temperature (i.e. between 15 and 30° C.). Alternatively, the fermented molasses can be at the temperature of the oil phase, or at a temperature close to the temperature of the oil phase (for example in a range of ±10° C. relative to the temperature of the oil phase).

The emulsion can advantageously be at a temperature higher than or equal to 40° C. In some embodiments, the emulsion can be at a temperature higher than or equal to 50° C. or higher than or equal to 60° C. Alternatively, the emulsion can be at ambient temperature. In some embodiments, the emulsion can be at a temperature of 5 to 15° C., or 15 to 30° C., or 30 to 40° C., or 40 to 50° C., or 50 to 60° C., or 60 to 70° C., or 70 to 80° C., or 80 to 90° C.

The emulsion prepared according to the invention can be used in any type of application.

The emulsion can advantageously be a bitumen emulsion i.e. the oil phase is a bitumen. Forming a bitumen emulsion allows fluidification of the bitumen and facilitates application thereof. The bitumens able to be used in the invention can be pure bitumen, modified bitumen or special bitumen, alone or in a mixture. They comprise bitumens of natural origin, those contained in deposits of natural bitumen, of natural asphalt or bituminous sands. The bitumens of the invention also comprise bitumens derived from the refining of crude oil. The bitumens are derived from atmospheric and/or vacuum distillation of oil. These bitumens can optionally be blown, visbroken and/or derived from a deasphalting process. The different bitumens obtained with refining processes can be combined together. The bitumen can also be recycled bitumen The bitumens can be soft grade or hard grade bitumens. The penetration value of the bitumen of the invention is preferably less than 800 tenths of mm at 25° C., measured according to standard NF EN 1426, for example a penetration value at 25° C. measured as per standard NF EN 1426 ranging from 10 to 30 tenths of mm, or from 30 to 50 tenths of mm, or from 50 to 100 tenths of mm, or from 100 to 200 tenths of mm, or from 200 to 300 tenths of mm, or from 300 to 400 tenths of mm, or from 400 to 500 tenths of mm, or from 500 to 600 tenths of mm, or from 600 to 700 tenths of mm, or from 700 to 800 tenths of mm.

The bitumen emulsion preferably has a temperature higher than 40° C., preferably higher than or equal to 50° C. or higher than or equal to 60° C.

Preferably, for the preparation of the bitumen emulsion, the bitumen is heated until it reaches a temperature higher than or equal to 70° C., preferably higher than or equal to 80° C., before it is mixed with the fermented molasses.

The bitumen emulsions of the invention can be used in various industrial applications, such as the roadway industry or roofing industry. For example, the bitumen emulsions can be used in the roadway industry to form the base courses, binder courses and/or sub-base courses of roadways. They can also be used for surfacing, in particular for trafficked areas. As areas that can be surfaced, mention can be made of roadways, car parks; pedestrian walkways such as sidewalks or terraces; urban amenities such as skateboard parks; sports surfaces or surfaces of industrial sites; flooring of cold storage rooms. The bitumen emulsions of the invention can also be used to prepare a seal coating, membrane or impregnation layer. The bitumen emulsions are adapted for the manufacture of waterproofing membranes, low-noise membranes, insulating membranes, surface coatings, carpet tiles, impregnation coats.

In other embodiments, the emulsion can be a petroleum emulsion (i.e. the oil phase is a petroleum), for example an emulsion of heavy crude oil. Preferably, the petroleum e.g. the heavy crude is heated until it reaches a temperature higher than or equal to 35° C., preferably higher than or equal to 40° C., before it is mixed with the fermented molasses.

The emulsion of the invention can be used in a large number of other industries or sectors, for example in the food industry, cosmetic industry, plant protection industry, pharmaceutical industry, paints and coatings industry, metallurgical industry, detergent and cleaning product industry, chemical industry, oil industry, adhesives industry.

Therefore, the emulsion can be used as, or can be included in, a food product such as an oil and vinegar dressing, or a cream.

Alternatively, the emulsion can be used as, or can be included in, a cosmetic product such as a cosmetic cream.

Alternatively, the emulsion can be used as, or can be included in, a plant protection product such as an insecticide, fungicide or herbicide.

Alternatively, the emulsion can be used as, or can be included in, a medicinal product, for example a medicinal product comprising an oily active ingredient.

Alternatively, the emulsion can be used as, or can be included in a paint, for example a paint comprising a pigment and/or resin in an oil-in-water emulsion.

Alternatively, the emulsion can be used as, or can be included in, a flotation medium.

Alternatively, the emulsion can be used as, or can be included in, a detergent or cleaning product such as a fabric and/or surface cleaning product, or furniture wax and/or shoe wax.

Alternatively, the emulsion can be used as, or can be included in, a reaction medium such as a polymerization medium, for performing emulsion polymerization.

Alternatively, the emulsion can be used as, or can be included in, an enhanced oil recovery fluid in particular an enhanced oil recovery fluid comprising petroleum as oil phase.

Alternatively, the emulsion can be a polymer emulsion (or latex). In this case, the emulsion contains at least one polymer preferably chosen from the group consisting of copolymers of styrene-butadiene (SBR), polysaccharides, starches, polyvinyl acetate polymers, polyacrylates, natural rubbers (NR), copolymers of styrene-butadiene-butylene-styrene (SBBS), copolymers of styrene-butadiene-styrene (SBS), copolymers of styrene-ethylene-butylene-styrene (SEBS), copolymers of styrene-ethylene-propylene-styrene (SEPS), copolymers of styrene-ethylene-ethylene-propylene-styrene (SEEPS), copolymers of styrene-isoprene-butadiene-styrene (SIBS), copolymers of styrene-isoprene-styrene (SIS), copolymers of styrene-isoprene, copolymers of styrene-ethylene-butylene, copolymers of styrene-ethylene-propylene, polybutadienes, polyisoprenes, and combinations thereof. The emulsion can be used as, or included in, an adhesive.

The invention also concerns an emulsion comprising a bitumen and a fermented molasses. The emulsion can be such as described above.

The invention also concerns an emulsion comprising a petroleum and a fermented molasses. The emulsion can be such as described above.

The invention also concerns a food product comprising, or consisting of, an emulsion comprising a fermented molasses and an oil phase. The emulsion can be such as described above.

The invention also concerns a cosmetic product comprising, or consisting of, an emulsion comprising a fermented molasses and an oil phase. The emulsion can be such as described above.

The invention also concerns a plant protection product chosen from among insecticides, fungicides and herbicides comprising, or consisting of, an emulsion comprising a fermented molasses and an oil phase. The emulsion can be such as described above.

The invention also concerns a medicinal product comprising, or consisting of, an emulsion comprising a fermented molasses and an oil phase. The emulsion can be such as described above.

The invention also concerns a paint comprising, or consisting of, an emulsion comprising a fermented molasses and an oil phase. The emulsion can be such as described above.

The invention also concerns a flotation medium comprising, or consisting of, an emulsion comprising a fermented molasses and an oil phase. The emulsion can be such as described above.

The invention also concerns a detergent or cleaning product comprising, or consisting of, an emulsion comprising a fermented molasses and an oil phase. The emulsion can be such as described above.

The invention also concerns a reaction medium such as a polymerization medium, comprising, or consisting of, an emulsion comprising a fermented molasses and an oil phase. The emulsion can be such as described above.

The invention also concerns an enhanced oil recovery fluid comprising, or consisting of, an emulsion comprising a fermented molasses and an oil phase. The emulsion can be such as described above.

### EXAMPLES

The following examples illustrate but do not limit the invention.

### Example 1 (Comparative Example)

An anhydrous powder obtained after removing water from fermented cane molasses was added in different concentrations (0.5%; 1%; 2%; 5%; and 10% by weight) to a heavy crude oil.

Microscopy observations of the compositions of heavy crude oil comprising 5 and 10 anhydrous powder showed that the powder is not dissolved in the heavy crude oil and has remained in the form of solid particles.

The viscosity of each of the mixtures of heavy crude oil and anhydrous powder, and the viscosity of a composition comprising 100% heavy crude oil were measured at 40° C. as a function of shear rate (over a range of 0.1 to 400 s⁻¹) with a DHR3 rheometer by TA Instruments in cone-plane configuration (cone of 1° and plane of 4 cm in diameter).

All the mixtures of heavy crude oil/anhydrous powder have viscosity which remains close to that of pure heavy crude oil. In total absence of water, the anhydrous extract of fermented molasses did not allow efficient reduction in the viscosity of the heavy crude oil.

### Example 2—Measurement of Interfacial Tension

The following compositions were tested:
DRM 1: fermented cane molasses comprising about 55% by weight of dry matter;
DRM 2: fermented beet molasses comprising about 60% by weight of dry matter;
DRM 3: water comprising 20 g/L of NaCl and no surfactant.

These three compositions were each mixed with a light crude oil (supplied by FAB) to create an interface between the composition and the light crude oil. The interfacial tension was measured at 60° C. with a K100 force tensiometer by Krüss equipped with a Wilhelmy plate.

A second test was conducted in which each of the three compositions DRM 1, DRM 2, DRM 3 were mixed with xylene to create an interface between the composition and the xylene. Interfacial tension was measured at 25° C. with the K100 force tensiometer with Wilhelmy plate.

The results are given in the Table below:

TABLE 1

| | |
|---|---|
| Mixture with light crude | Mixture with xylene |
| oil (60° C.) | (25° C.) |

| | | | | |
|---|---|---|---|---|
| DRM 3 | 12.2 | mN/m | 24.0 | mN/m |
| DRM 1 | 4.4 | mN/m | 10.2 | mN/m |
| DRM 2 | 2.4 | mN/m | 5.7 | mN/m |

It is ascertained that the fermented molasses each allow an interfacial tension to be obtained, when mixed with an oil phase, that is lower than that of an aqueous solution with 20 g/L of NaCl, indicating that the fermented molasses potentially have surface activity.

It is also observed that the fermented beet molasses allows a lower interfacial tension to be reached (by a factor of almost 2) than the fermented cane molasses.

### Example 3—Emulsions of Heavy Crude Oil

An emulsion (Emulsion No 1) was prepared with an ULtraTurrax T25 homogenizer as follows. A mass of 45 g (34 ml) of fermented molasses DRM 1 (such as described in Example 2 above) was placed in a beaker. The heavy crude oil was heated to a temperature of 40° C. in an oven. It was then poured by means of a syringe in an amount of 30 mL into the fermented molasses, while the preparation was mixed with the homogenizer set at 20000 rpm. Mixing was continued for 5 minutes. The emulsion comprises 47% by volume of heavy crude oil.

A second emulsion (Emulsion No 2) was prepared in the same manner as Emulsion No 1 except that fermented molasses DRM 2 was used (as described in Example 2 above) instead of fermented molasses DRM 1.

A droplet of Emulsion No 2 was placed in tap water. The droplet dispersed in the water; the emulsion is therefore an oil-in-water emulsion. A droplet of Emulsion No 2 was also placed in heptane. The droplet did not disperse in the heptane, confirming that the continuous phase of the emulsion is the aqueous phase.

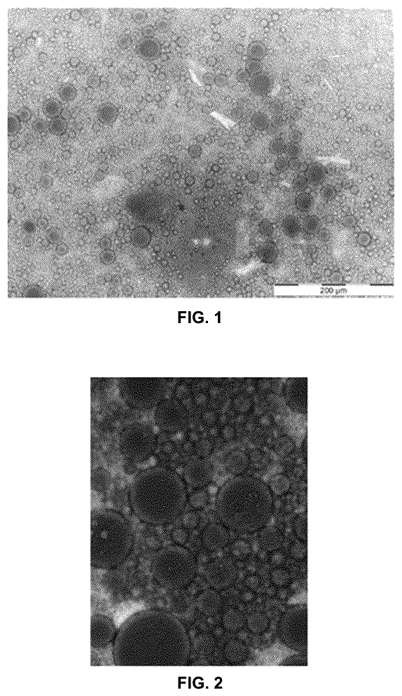

The two Emulsions No 1 and No 2 were observed under an optical microscope. The optical microscopy images are given in FIGS. 1 and 2.

It is observed that both emulsions contain droplets of oil phase which are rather polydisperse. The presence of fermented molasses therefore allowed the forming of an emulsion.

Rheological measurements were also carried out on Emulsions No 1 and No 2: viscosity was measured at 40° C. with a rheometer in plane-plane configuration (rough parallel plates 4 cm in diameter) with an air gap of 750 μm to limit the slide effect. Measurement of the viscosity of pure heavy crude oil with the same geometry and measurement with cone-plane geometry were also carried out.

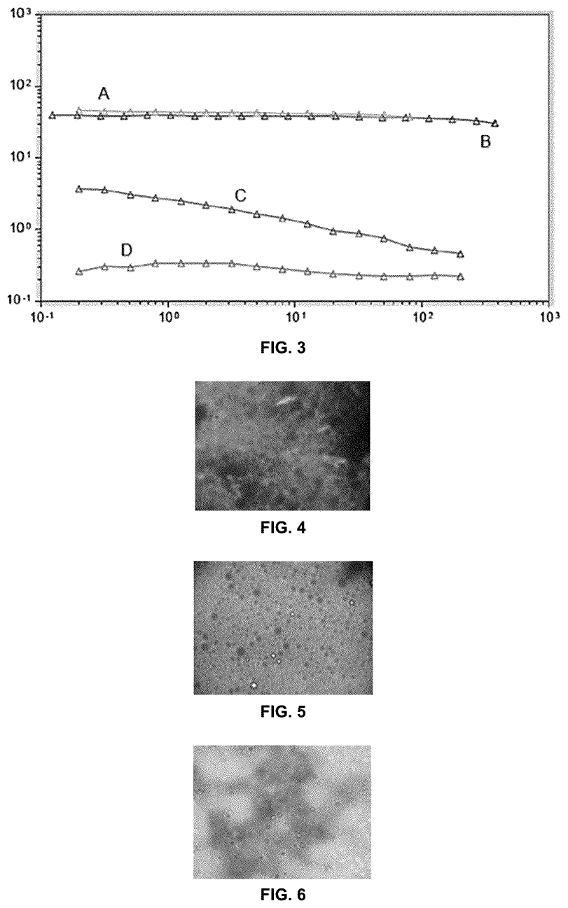

The results are given in FIG. 3.

It is ascertained that the emulsions of fermented molasses/heavy crude oil have viscosity that is much lower than that of heavy crude oil.

### Example 4—Bitumen Emulsions

Tests were conducted with Esso 160200 bitumen.

An emulsion (Emulsion No 3) was prepared as follows: the bitumen was heated to a temperature of 80° C. and a volume of 51 mL of bitumen was added to 45 g (34 mL) of fermented molasses DRM1, to reach a quantity of bitumen of 60% by volume. The mixture was mixed for 5 minutes with an UltraTurrax homogenizer at 20000 rpm.

A second emulsion (Emulsion No 4) was prepared in the same manner as Emulsion No 3, except that fermented molasses DRM 2 was used instead of fermented molasses DRM 1.

A third emulsion (Emulsion No 5) was prepared in the same manner as Emulsion No 4, except that the amount of bitumen added to fermented molasses DRM 2 was such that the emulsion comprised 70% by volume of bitumen.

Emulsions No 3, No 4, and No 5 were observed under an optical microscope. The optical microscopy images are given in FIGS. 4, 5 and 6.

It is ascertained that the oil phase droplets are rather polydisperse. The presence of fermented molasses therefore allowed the forming of bitumen emulsions.

The three emulsions No 3, No 4 and No 5 are stable.

A droplet of each emulsion was added to water and to heptane: for each emulsion the droplet dispersed in the water but not in the heptane: emulsions No 3, No 4 and No 5 are oil-in-water emulsions.

Rheological measurements were performed on the three emulsions No 3, No 4 and No 5 and on pure Esso 160200 bitumen. Viscosity was measured at 40° C. with a rheometer in plane-plane configuration (parallel plates 4 cm in diameter) with Peltier plate.

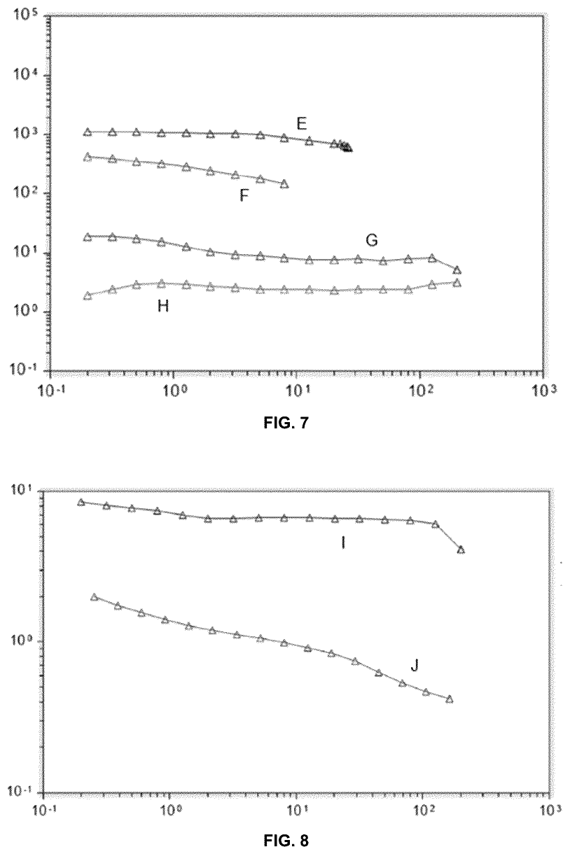

The results are given in FIG. 7.

It is ascertained that the emulsions of fermented cane or beet molasses and 60% by volume of bitumen (Emulsions No 3 and No 4) have much lower viscosity than that of pure bitumen. The fermented beet molasses allows a greater reduction in viscosity than fermented cane molasses.

In addition, a reduction in viscosity (compared with pure bitumen) was also observed in Emulsion No 5 comprising 70% by volume of bitumen.

### Example 5—Bitumen Emulsions at 50% by Volume

A bitumen emulsion (Emulsion No 6) was prepared in the same manner as Emulsion No 3 except that the amount of bitumen added to fermented molasses DRM 1 was 50% by volume.

Rheological measurements were performed on this emulsion and on pure bitumen. Viscosity was measured at 40° C. with a rheometer in plane-plane configuration (parallel plates 4 cm in diameter) with a Peltier plate.

The results are given in FIG. 8.

It is ascertained that the addition of fermented cane molasses to the bitumen to form an emulsion allows a significant reduction in viscosity.

The emulsion was left to cool and phase separation was observed when the temperature of the emulsion fell to 40° C. This could be advantageous in bitumen applications in which breaking of the emulsion is generally required after pouring the bitumen.

### Example 6—Rapeseed Oil Emulsions

Two emulsions comprising 60% by weight of rapeseed oil and 40% by weight of fermented molasses respectively having a pH of 10 (Emulsion No 7) and a pH of 6 (Emulsion No 8) were prepared. The fermented molasses used to prepare these emulsions was a fermented molasses comprising from 80 to 90% of fermented beet molasses and from 10 to 20% of fermented cane molasses, having a dry matter content of 60% and pH of 6. To prepare Emulsion No 7, an aqueous solution of potassium hydroxide at 50% by weight was added to the fermented molasses until a pH was obtained of between 10 and 11. Very slight dilution is observed when the pH of the fermented molasses is increased.

The preparation of the emulsions was carried out as follows. The rapeseed oil was heated to a temperature of 60° C. and an amount of 60 g of oil was added at once to 40 g of fermented molasses also heated to the same temperature, to reach a quantity of oil of 60% by weight. The mixture was mixed for 1 minute with an UltraTurax homogenizer at 12 000 rpm and then poured when hot into two centrifugation tubes to monitor forced stability (accelerated phase separation by centrifugation) and stability over time (after 20 days). To force separation, one of the two tubes was centrifuged at 8 000 rpm for 10 minutes at 20° C., 2h after preparation of the emulsion.

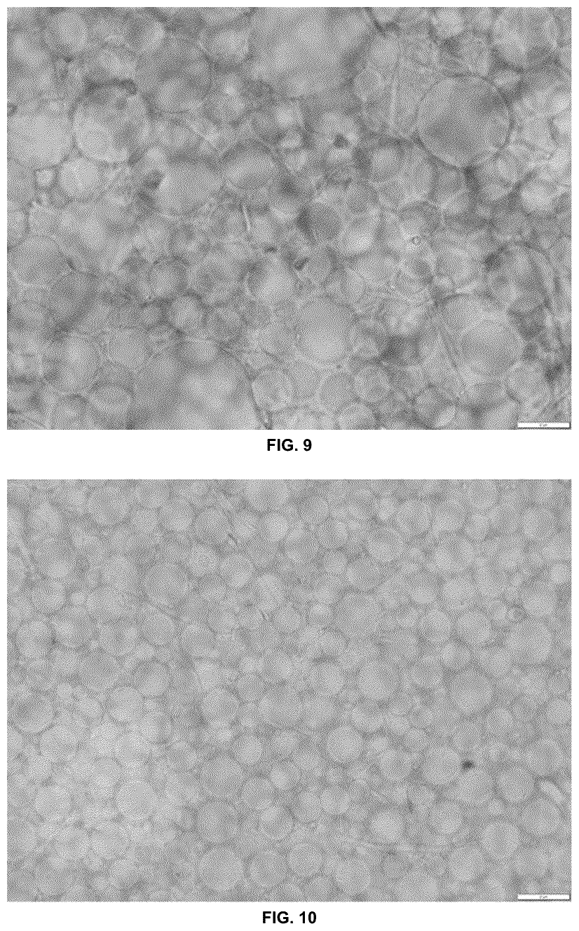

The two emulsions No 7 and No 8 were observed under an optical microscope after their preparation (before centrifugation). The optical microscopy images are given in FIGS. 9 and 10.

For both emulsions, monodispersed droplets of oil phase were observed in the aqueous phase. An emulsion was therefore formed. The size of the droplets was close to 10 μm.

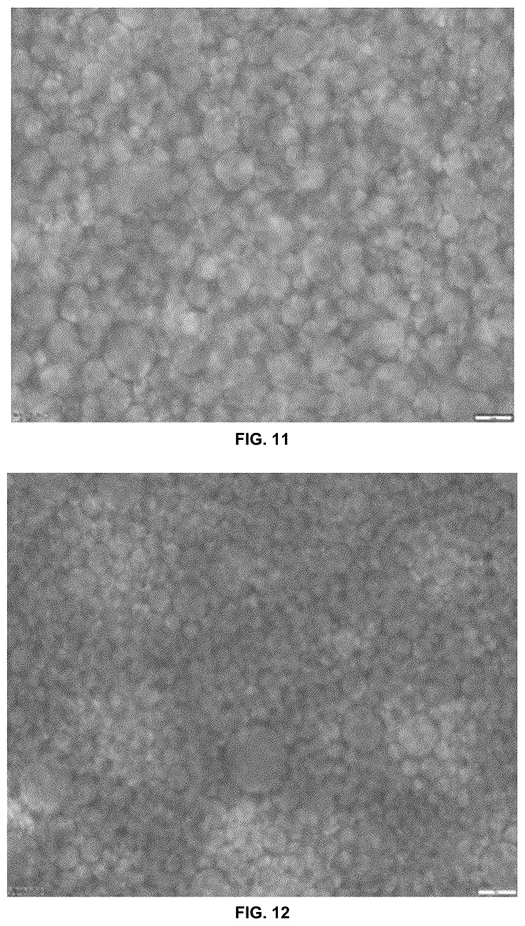

The conical polypropylene tubes containing emulsions No 7 and No 8 for the study on the stability of the emulsions over time (i.e. the tubes that were not centrifuged) were stored at ambient temperature for 20 days, after which emulsions No 7 and No 8 were observed under an optical microscope. The optical microscopy images are given in FIGS. 11 and 12.

The droplets of oil remained dispersed in the aqueous phase for both emulsions, and no creaming was observed: the emulsions are stable over time. The size of the droplets progressed towards a size close to an average of 20 μm. In the emulsion at pH 10, coalescence was lower and the droplets remained monodispersed 20 days after preparation of the emulsion, whereas the droplets were more polydisperse in the emulsion at pH 6 after a storage time of 20 days, which could indicate that the stability of the emulsion is greater at pH 10 than at pH 6.

### Example 7—Emulsions of Demineralized Fermented Molasses

Two emulsions comprising 60% by weight of rapeseed oil and 40% by weight of diluted demineralized fermented molasses, respectively having a pH of 10 (Emulsion No 9) and a pH of 3 (Emulsion No 10) were prepared. The fermented molasses used to prepare these emulsions were fermented molasses comprising 85 to 95% fermented beet molasses and 5 to 15% fermented cane molasses. They contained 70% by weight of dry matter and 30% by weight of water (the dry matter before demineralization comprising about 85% by weight of organic matter and 15% by weight of mineral matter). Demineralization of the fermented molasses was performed by addition of sulfuric acid followed by separation of the crystals obtained. Before being incorporated in the emulsions, the fermented molasses were diluted by adding 33.3 g of distilled water to 66.7 g of fermented molasses, so that the same amount of organic matter was added to these emulsions as contained in Emulsions No 7 and No 8 in Example 6. To prepare Emulsion No 9, an aqueous solution of potassium hydroxide at 50% by weight was added to the demineralized fermented molasses until a pH was obtained of between 10 and 11.

Emulsions No 9 and No 10 were then prepared in the manner described for Emulsions No 7 and No 8 in Example 6.

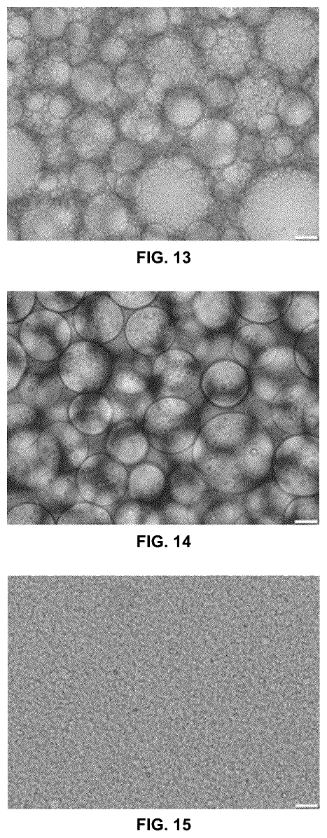

Both Emulsions No 9 and No 10 were observed under an optical microscope after their preparation. The optical microscopy images are given in FIGS. 13 and 14.

It is ascertained that for both emulsions (at pH 10 and at pH 3), oil droplets are stably dispersed in the aqueous phase. Emulsions were therefore obtained. In addition, the viscosity of Emulsion No 9 (at pH 10) is higher than that of Emulsion No 10 (at pH 3), the increase in pH promotes stability of the emulsion.

### Example 8—Emulsions of Depotassified Fermented Molasses

Two emulsions comprising 60% by weight of rapeseed oil and 40% by weight of depotassified fermented molasses respectively having a pH of 6 (Emulsion No 11) and a pH of 10 (Emulsion No 12) were prepared. The fermented molasses used to prepare these emulsions were fermented molasses comprising from 85 to 95% of fermented beet molasses and from 5 to 15% of fermented cane molasses, and having a dry matter content of about 60% by weight. The molasses were depotassified by precipitation of potassium through the addition of sulfuric acid followed by separation of the crystals obtained, then by carrying out neutralization by adding ammonia until a pH of 6 is reached. To prepare Emulsion No 12, an aqueous solution of potassium hydroxide at 50% by weight was added to the depotassified fermented molasses until a pH was obtained of between 10 and 11.

Emulsions No 11 and No 12 were then prepared in the manner described for Emulsions No 7 and No 8 in Example 6.

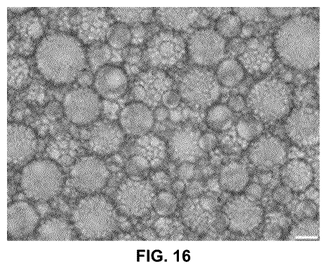

Both Emulsions No 11 and No 12 were observed under an optical microscope after their preparation. The optical microscopy images are given in FIGS. 15 and 16.

It is observed that Emulsions No 11 (at pH 6) and No 12 (at pH 10) contain stable oil droplets dispersed in the aqueous phase. Emulsions were formed at pH 6 and at pH 10.

### Example 9—Emulsions with Different Amounts of Oil

Emulsions of oil and fermented molasses were prepared in the same manner as Emulsion No 8 in Example 6, but with the proportions of rapeseed oil and fermented molasses given below.

| Emulsion No | 13 | 14 | 15 |
|---|---|---|---|
| Rapeseed oil (weight %) | 30 | 40 | 50 |
| Fermented molasses (weight %) | 70 | 60 | 50 |

Emulsions No 13 to 15 were observed under optical microscopy after their preparation: in each one, droplets of oil phase having a size of about 2 to 5 μm are stably monodispersed in the aqueous phase.

Forced stability (by centrifugation) of these emulsions was also studied in the manner described in Example 6. Emulsions No 13 to 15 remained stable.

### Example 10—Emulsions of Different Oils

Two emulsions comprising 60% by weight of oil and 40% by weight of fermented molasses were prepared in the same manner as Emulsion No 8 in Example 6, with the exception that either sunflower oil (Emulsion No 16) or grapeseed oil (Emulsion No 17) were used instead of rapeseed oil.

Emulsions No 16 and No 17 were observed under optical microscopy after their preparation. The emulsions comprise droplets of oil phase monodispersed in the aqueous phase and are stable. The droplets of Emulsion No 16 have a size of about 3 to 8 μm, and those of Emulsion No 17 have a size of about 4 to 8 μm.

These emulsions were also tested for forced stability (via centrifugation) in the manner described in Example 6. These emulsions remained stable.

1. Method for producing an emulsion comprising using a fermented molasses as an emulsifier in the emulsion.

2. The method according to claim 1, wherein the emulsion is an oil-in-water emulsion.

3. The method according to claim 1, wherein the fermented molasses is chosen from the group consisting of fermented beet molasses, fermented cane molasses and combinations thereof.

4. The method according to claim 1, wherein the fermented molasses is fermented beet molasses.

5. The method according to claim 1, wherein the fermented molasses is demineralized fermented molasses.

6. The method according to claim 1, wherein the fermented molasses is depotassified fermented molasses.

7. The method according to claim 1, wherein the fermented molasses is contained in the emulsion in an amount of from 25 to 85% by weight, relative to the total weight of the emulsion.

8. The method according to claim 1, wherein the emulsion comprises an amount of oil phase of from 15 to 75% by weight, relative to the total weight of the emulsion.

9. The method according to claim 1, wherein the fermented molasses has a dry matter content of from 50 to 90% by weight.

10. The method according to claim 1, wherein the pH of the emulsion is from 2 to 11.

11. The method according to claim 1, wherein the emulsion is a bitumen or petroleum emulsion.

12. The method according to claim 1, wherein the emulsion is at a temperature higher than 40° C.

13. The method according to claim 1, wherein the emulsion is or is included in a food product, a cosmetic product, a plant protection product, a medicinal product, a paint, a flotation medium, a detergent or cleaning product, a reaction medium, an enhanced oil recovery fluid, or an adhesive.

14. An emulsion comprising a bitumen and a fermented molasses.

15. The method according to claim 1, wherein the fermented molasses is contained in the emulsion in an amount of from 25 to 60% by weight, relative to the total weight of the emulsion.

16. The method according to claim 1, wherein the fermented molasses is contained in the emulsion in an amount of from 25 to 50% by weight, relative to the total weight of the emulsion.

17. The method according to claim 1, wherein the fermented molasses is contained in the emulsion in an amount of from 30 to 40% by weight, relative to the total weight of the emulsion.

18. The method according to claim 1, wherein the emulsion comprises an amount of oil phase of from 40 to 75% by weight, relative to the total weight of the emulsion.

19. The method according to claim 1, wherein the emulsion comprises an amount of oil phase of from 50 to 75% by weight, relative to the total weight of the emulsion.

20. The method according to claim 1, wherein the emulsion comprises an amount of oil phase of from 60 to 70% by weight, relative to the total weight of the emulsion.
